(19) United States
(12) Patent Application Publication
(10) Pub. No.: US 2026/0086271 A1
(43) Pub. Date: Mar. 26, 2026

(54) Hybrid Surface Topology Metalens

(71) Applicant: Mitsubishi Electric Research Laboratories, Inc., Cambridge, MA (US)

(72) Inventors: Matthew Brand, Newton, MA (US); Lin Deng, Boston, MA (US)

(73) Assignee: Mitsubishi Electric Research Laboratories, Inc., Cambridge, MA (US)

(21) Appl. No.: 18/892,804

(22) Filed: Sep. 23, 2024

(51) Int. Cl. G02B 3/02; G02B 27/00; G06N 5/01

(52) U.S. Cl. CPC G02B 3/02; G02B 27/0012; G06N 5/01

(57) ABSTRACT

A metalens with a hybrid surface topology that includes a collection of nanopillars and a collection of nanogratings.

### TECHNICAL FIELD

This disclosure relates to optics, and more specifically to metalens surface topologies.

### BACKGROUND

A metalens is a surface decorated with sub-wavelength scale structures that interact with an electromagnetic field, typically providing some optical function similar to a lens. The shaping of these structures—a problem known as topology optimization—is still a very challenging problem with current methods requiring enormous computational resources and achieving only limited improvements over initial conditions. Consequently, the dominant design strategy is to decompose the domain into sub-wavelength scale unit cells and choose topologies for each cell from a library of parametric tile designs whose contribution to the performance goal is known from simulation. Miyata et al. showed how to choose and arrange sub-wavelength tiles to form a metalens that sorts incoming light by polarization and simultaneously focuses four distinctly polarized images of the scene. This is an example of forward design. Brand and Kuang developed a tile shape (a.k.a. topology) optimization algorithm that generates more efficient polarization-sorting meta lenses and showed how to reconstruct the 3D geometry of the scene from as little as two distinctly polarized images. This is an example of inverse design, because information from the performance objective is propagated backwards to inform changes to the nanostructures.

It is expected that completely freeform metalens designs outperform tiled designs. However, freeform metalens design can be computationally prohibitive and its fabrication challenging due to the irregularity of freeform metalens surface profiles.

Accordingly, there is a need for the surface topology of metalens that outperforms tile design but can be computationally less expensive to compute than the design of the freeform topology.

### SUMMARY

Metalenses are a type of lens that uses arrays of subwavelength-scale structures, such as nanopillars, to manipulate light according to a desired objective. These structures manipulate the phase of light passing through them, allowing for much thinner optical devices compared to traditional refractive lenses. Nanopillars are tiny pillars with sub-wavelength dimensions on the order of hundreds of nanometers or less.

Metalenses use nanopillars to achieve a high numerical aperture, which can be advantageous for imaging systems because it determines the lens's ability to resolve detail. They can also be designed to operate across a broad range of wavelengths, making metalenses useful for applications such as microscopy, cameras, and other optical systems.

On one hand, the metalenses with nanopillars have the potential for high efficiency, as they can be designed using principles of tiled design to efficiently couple light into the desired modes. They also offer flexibility in terms of tuning their properties by adjusting the size, shape, and spacing of the nanopillars via a process referred to herein as topology optimization. For example, the Unit Cell Decomposition (UCD) technique provides a way for designing the nanopillars of metalenses by arranging nanopillars of a predetermined geometry on a grid or tiles and by varying parameters of the geometry to improve the performance of the metalens according to a task on hand. This approach simplifies the computation, but still, the complexity of the computation allows the optimization of only a small number of geometrical parameters, such as the size and/or orientation of the nanopillars.

As an alternative to the nanopillar's configuration, freeform metalenses do not have a regular, periodic surface structure. Instead, they have arbitrarily irregular surface patterns that are designed to manipulate light in specific ways. The irregular patterning of freeform metalenses allows flexibility in controlling the phase and amplitude of light, enabling applications such as aberration correction, beam shaping, and general wavefront manipulation. While freeform metalenses can outperform nanopillar topologies, the freeform topology optimization involved in designing freeform metalenses for a specific task can be computationally prohibitive. Also, fabricating freeform metalenses can be challenging, as their irregular surface profiles require advanced manufacturing techniques such as 3D printing or lithography.

Accordingly, there is a need to provide a system and a method for designing metalenses that can outperform the nanopillar arrangement but simplify the computation and fabrication of the metalenses with freeform topology.

Some embodiments are based on recognizing that while the sub-wavelength dimensions of the nanopillars bring some advantages for phase manipulation of the incoming electromagnetic field, strictly sub-wavelength manipulation of the incoming field allows some energy to spill into higher modes, preventing focusing the light in a manner possible by metalenses having both sub- and supra-wavelength freeform topology. In other words, due to the physics of light manipulation, to reduce energy spill and to improve the focusing of light, some nanopillars should have supra-wavelength dimensions. Additionally, device performance and efficiency can be improved by allowing all nano-structures to have freeform shapes. Unfortunately, designing a metalens of practical size with freeform and supra-wavelength nanopillars is too resource-intensive for current methods of topology optimization.

To that end, some embodiments disclose metalens with a hybrid surface topology including a collection of sub-wavelength elements, i.e., referred to herein as nanopillars, and a collection of supra-wavelength elements, referred to herein as nanogratings. The combination of nanopillars with nanogratings allows for mimicking the performance of freeform lenses in a computationally efficient manner. The combination of sub- and supra-wavelength elements in the hybrid surface topology increases the number of light-manipulating elements per square footage of the lens while still providing supra-wavelength elements to reduce energy spill.

For example, some embodiments are based on recognizing that an arrangement of nanopillars forming a topology of metalens configured for a specific task with, for example, the principles of tiles design, can be further modified to reduce the energy spill with nanogratings. In other words, the nanopillars designed for a task can be used as initialization for the topology optimization method allowing the formation of nanograting to reduce energy spill. For a number of practical tasks, when nanopillars topology is optimized for energy spill reduction, the result of optimization would be nanopillars and nanogratings of irregular shapes with the nanogratings formed by merging shapes of at least two nanopillars in neighboring cells. In some embodiments the irregularity of the shape refers to shapes not commonly seen in the field of practice, but still relevant to the design task at hand. The analogy of nanograting formation is like merging drops of liquid with surface tension to reduce the energy associated with the increase in surface area as the drops combine.

To that end, some embodiments use two-stage optimization to design the hybrid surface topology for the metalenses performing a task. During the first state, the metalens with regular shaped nanopillars is designed to perform a task. During the second stage, the nanopillar topology is optimized with the objective of focal efficiency and minimum energy spill to produce irregularly shaped nanopillars and nanogratings.

Notably, for computational efficiency purposes, in some embodiments, the hybrid surface topology is optimized over a collection of overlapping tiles, i.e., each tile including multiple unit cells containing nanopillars. Despite the fact that overlapping cells are optimized multiple times in separate tiles, the results of the optimization in the overlapping cells are converging or at least not diverging.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 shows an isometric view of a hybrid surface topology metalens, according to embodiments of the present disclosure.

FIG. 2A shows a schematic of a metalens configured to manipulate an incoming wavefront of electromagnetic waves according to embodiments of the present disclosure.

FIG. 2B shows an isometric view of a metalens patch according to embodiments of the present disclosure.

FIG. 2C shows a top view of a metalens patch according to embodiments of the present disclosure.

FIG. 2D shows a top view of a metalens patch containing nanostructures with irregular shapes according to embodiments of the present disclosure.

FIG. 3A shows a schematic of a method for designing a hybrid surface topology of a metalens according to some embodiments.

FIG. 3B shows a schematic depicting the formation of a nanograting, according to embodiments of the present disclosure.

FIG. 3C shows a schematic depicting formation of an irregularly shaped nanograting, according to embodiments of the present disclosure.

FIG. 4A shows a schematic of an optimization problem according to some embodiments of the present disclosure.

FIG. 4B shows principal steps involved in optimizing freeform design.

FIG. 5A shows a schematic of an optimization problem including the morphology term according to embodiments of the present disclosure.

FIG. 5B shows a flowchart for achieving a hybrid topology metalens by solving the optimization function according to embodiments of the present disclosure.

FIG. 5C shows a schematic of a patch of metalens before and after optimization, illustrating the effect of the morphology terms according to embodiments of the present disclosure.

FIG. 6A shows a flowchart for achieving a hybrid metalens topology by dependent optimization or independent optimization according to embodiments of the present disclosure.

FIG. 6B shows a schematic of independent optimization according to embodiments of the present disclosure.

FIG. 6C shows an alternate view of independent optimization according to embodiments of the present disclosure.

FIG. 6D shows a diagram demonstrating a method for optimization of a metalens topology according to embodiments of the present disclosure.

FIG. 7A shows a table illustrating the maximum deflection angle of a hybrid topology metalens.

FIG. 7B shows an instance of a hybrid surface topology metalens according to some embodiments of the present disclosure.

FIG. 8 shows an example configuration of a computing module involved in producing a hybrid topology metalens according to some embodiments of the present invention.

FIG. 9 shows a diagram illustrating an overview of the manufacturing process relative to a hybrid topology metalens used by some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

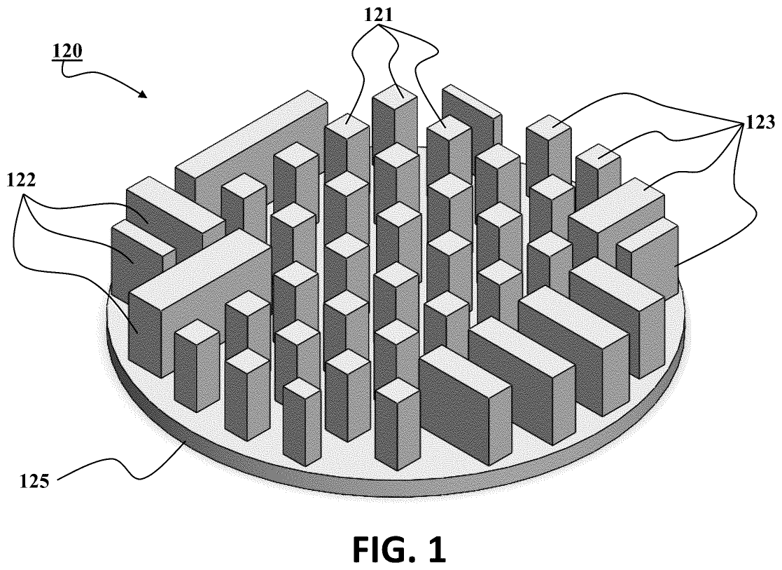

FIG. 1 shows an isometric view of a metalens 120 having a hybrid surface topology according to an embodiment of the present disclosure. The hybrid surface topology of metalens 120 includes a collection of nanopillars 121 and a collection of nanogratings 122 arranged on a substrate 125. Collectively, the nanopillars and nanogratings form the hybrid surface topology 123 of the metalens 120.

In various implementations, the nanopillars and nanogratings in collection 123 can have various sizes, shapes, and/or angles of orientation in dependence on a task for which the metalens 120 is designed. However, in contrast with nanopillars 121 having maximum dimensions of their length, width, and height in the sub-wavelength domain, at least one dimension, e.g., width, of the nanograting belongs to the super-wavelength domain governed by the wavelength of the light the metalens 120 is designed to manipulate.

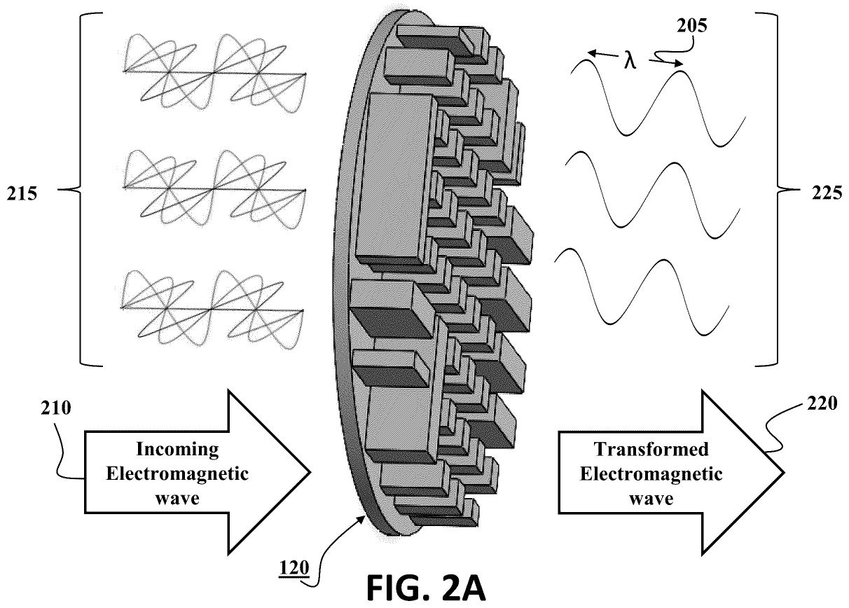

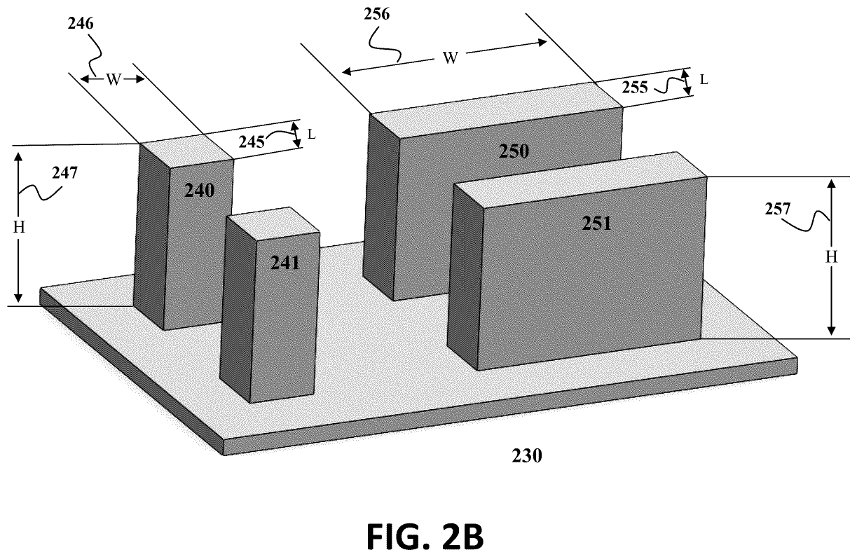

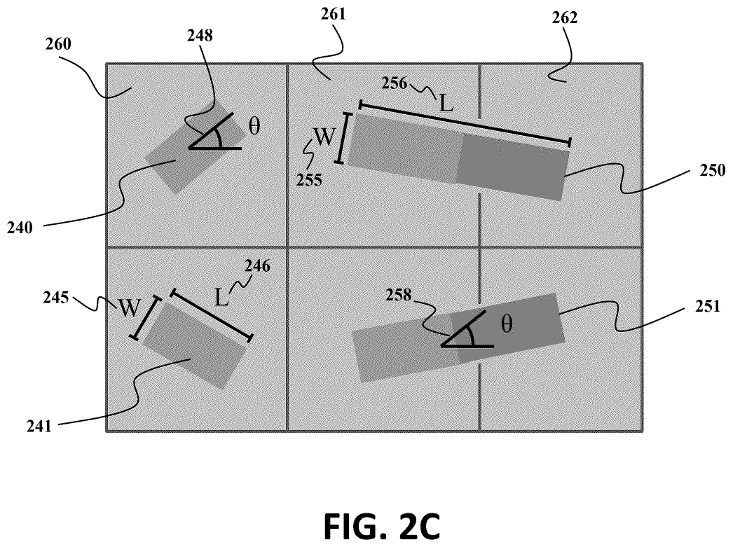

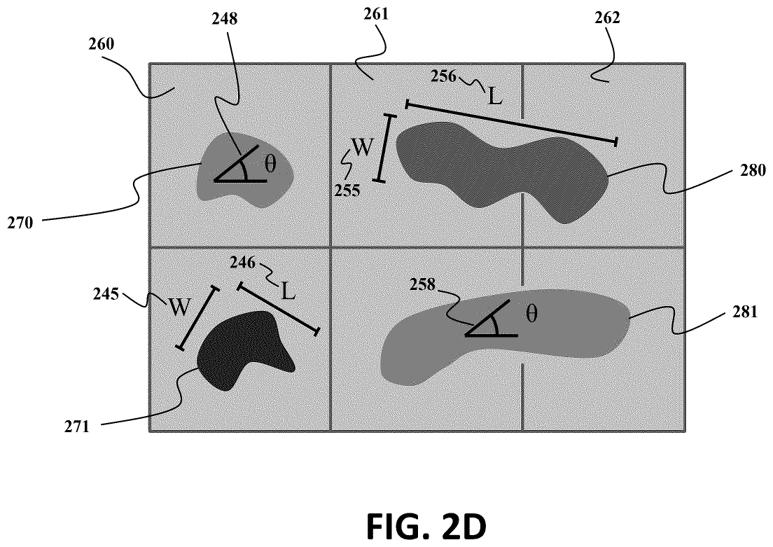

FIG. 2A shows a metalens 120 configured to manipulate an incoming wavefront of electromagnetic waves 210 into transformed electromagnetic waves 220 according to some embodiments. For example, electromagnetic wave 210 includes unpolarized light 215 and metalens 120 is designed to transform the unpolarized light 215 into polarized light 225. To that end, the hybrid topology of the metalens 120 is selected according to the task for light manipulation and the sub- and and supra-wavelength dimensions of the nanopillars and nanogratings of the metalens 120 are governed by the wavelength 205 of the manipulated light.

FIG. 2B shows an isometric view of a patch 230 of metalens including both nanopillars and nanogratings according to an embodiment of the present disclosure. Each nanopillar 240 and/or 241 can be identified by either its width 246, length 245, or height 247 with respect to the wavelength of incoming electromagnetic light. Similarly, each nanograting 250 and/or 251 can also be identified by either its width 256, length 255, or height 257 with respect to the wavelength of incoming electromagnetic light. In some embodiments, the heights 247 and 257 of the nanopillars and nanogratings are preselected to be the same throughout the metalens and agnostic to the task. However, widths 246 and 256 as well as lengths 245 and 255 of the nanopillars and nanogratings are selected and optimized according to a task such as light manipulation and can vary among different elements. In this example, the width 256 of each of the nanograting has a supra-wavelength dimension, while the width 246 of the nanopillars as well as the lengths 245 and 255 of the nanopillars and nanogratings have sub-wavelength dimensions.

FIG. 2C shows a top view of a patch of metalens according to an embodiment of the present disclosure. As shown in this figure, the topology of the metalens is organized on a grid forming cells 260. In this embodiment, the grid has a square cellular arrangement. However, in other embodiments, the grid has different arrangements of cells, such as hexagonal or bipolar arrangements.

The cells have sub-wavelength dimensions and each of the nanopillars 240 and 241 are located within a cell. The dimensions, such as width 245 and length 246 of the nanopillars as well as their orientations 248 are selected to change the phase of light according to the task at hand. In contrast, the nanogratings, such as nanogratings 250 and 251, can occupy multiple cells 261 and 262. The dimensions of the nanogratings, such as width 255 and length 256, as well as their orientations 258, are also selected to change the phase of light according to the task.

As seen in FIG. 2C, each nanograting can be imagined as a combination of two or more nanopillars. Using this analogy, some embodiments are based on recognizing that an arrangement of nanopillars forming a topology of a metalens configured for a specific task can be used as initialization for the topology optimization method allowing the formation of nanogratings to reduce energy spill.

FIG. 2D similarly shows a top view of a patch of metalens according to an embodiment of the present disclosure. This embodiment is arranged on a grid forming cells 260 organized in a square cellular arrangement. Within the sub-wavelength cells are nanopillars of irregular shapes 270 and 271. Nanopillars 270 and 271 can also be designed according to their dimensions when manipulating the phase of light for a given task. The shape of the nanopillars themselves can be altered to appropriately influence the phase of incoming light through dimensions such as width 245, length 246, and orientation 248. Having nanopillars and nanogratings of irregular shape allows for improving the focal efficiency of the resulting metalens.

Furthermore, nanogratings can also take on various shapes according to the design task at hand. Irregularly shaped nanogratings 270 and 271 measured with respect to their width 255, length 256, and orientation 258 form in accordance with the design task or objective at hand. Different initial requirements and goals can yield differently shaped nanopillars and nanogratings. Changes in the phase of light may require a certain nanopillar/nanograting shape while the manipulation of phase in another application may call for differently shaped nanopillars and nanogratings.

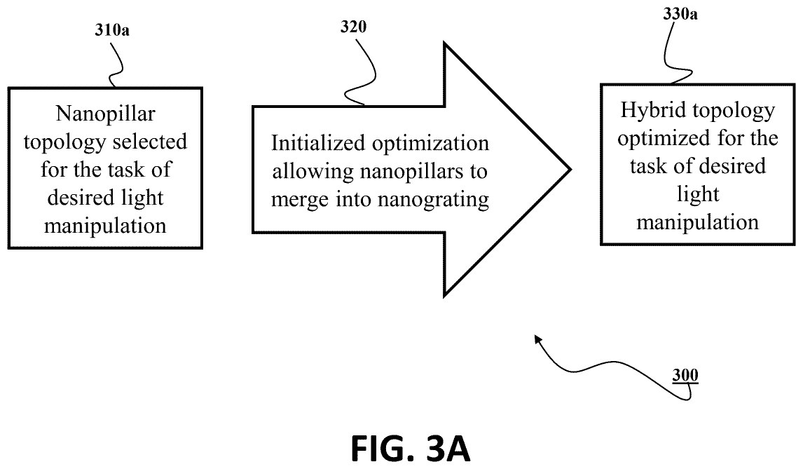

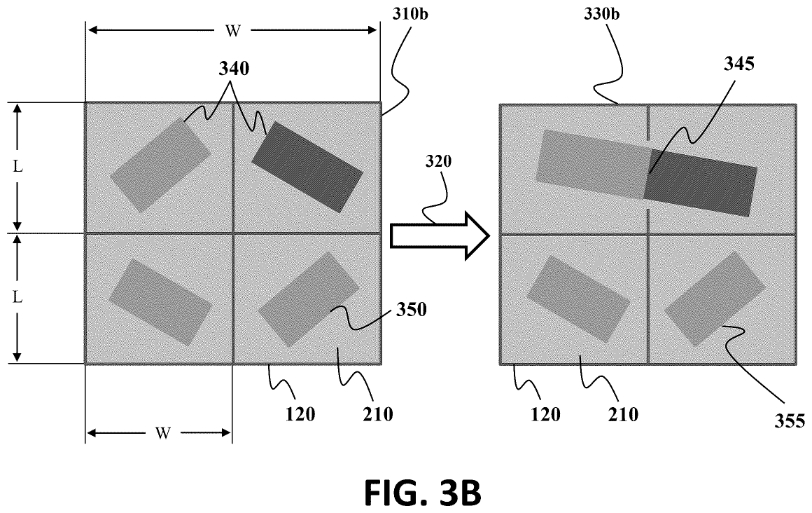

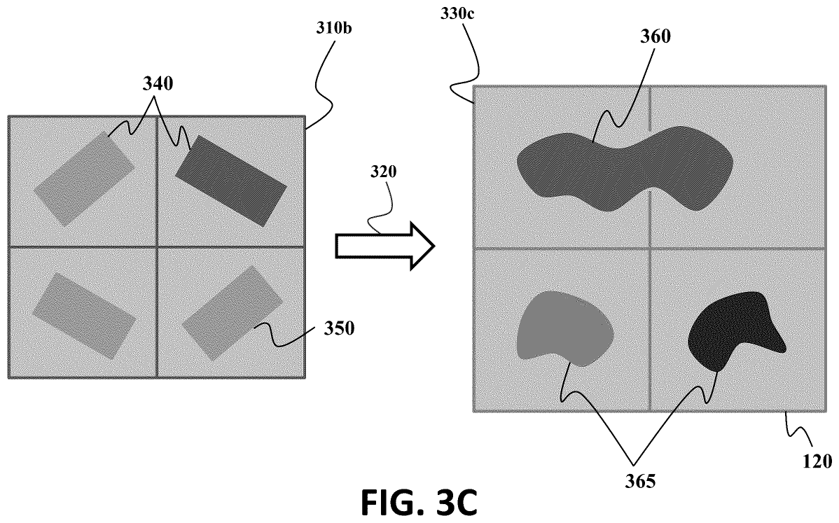

FIG. 3A shows a schematic of a method for designing a hybrid surface topology of a metalens according to some embodiments. The method is performed using a processor 300 coupled with executable instructions for implementing the method.

First, the method determines 310a a collection of nanopillar topology selected for the task of desired light manipulation. For example, the method selects the topology for the task of changing the polarization of light. To that end, the processor 300 can be connected through a wired or wireless interface to a memory (not shown) storing a library of different nanopillar arrangements predetermined for different tasks. Such a library can be determined with forward or inverse tiles design methods. Additionally, or alternatively, the method can determine the arrangement 310a using various forward and/or inverse design techniques in response to receiving a task for light manipulation.

Next, the method determines the hybrid surface topology 330a by optimizing 320 nanopillar topology 310a with an objective of focal efficiency and minimum energy spill. Such an initialization simplifies the computation and when the optimization 320 is initialized with topology 310a, the nanopillars merge into nanogratings achieving the objectives of focal efficiency and minimum energy spill. The initial objectives of optimization for focal efficiency, and energy spill, when initialized with nanopillars produce nanogratings as an unexpected and/or surprising byproduct resulting from the merging of nanopillars to improve the optimization objectives.

FIG. 3B shows a patch of metalens, before and after freeform optimization according to an embodiment of the present disclosure. The initial patch of metalens contains nanopillars 340 arranged throughout square grid cells 210 into an arrangement 310b defined by the size and orientations of the nanopillars. Each of the square grid cells 210 can be measured with respect to their sub-wavelength dimensions as well as width or length according to some embodiments. After optimization 320, arrangement 310b is transformed into the arrangement 330b which includes a nanograting 345 formed by merging and reshaping nanopillars 340 and a nanopillar 355 transformed from the nanopillar 350 by changing its shape and/or orientation.

FIG. 3C shows a patch of metalens, before and after freeform optimization according to another embodiment of the present disclosure. For a number of practical tasks, when the nanopillar topology is optimized for energy spill reduction, the result of optimization would be nanopillars and nanogratings of irregular shapes with the nanogratings formed by merging shapes of at least two nanopillars in neighboring cells. The analogy of nanograting formation is like merging drops of liquid with surface tension to reduce the energy associated with the increase in surface area as the drops combine. A top view patch 330c of a metalens 120, includes two irregularly shaped nanopillars 365 formed by modifying the original shape of nanopillars 350 and one irregularly shaped nanograting 360 formed by modifying and merging nanopillars 340.

On their own metalens topologies consisting of only nanopillars are simpler in design but are limited in their efficiency and ability to manipulate light. The reconfiguration of nanopillars with sub-wavelength features according to a task can only give so much room for the manipulation of incident light. Some embodiments are based on the understanding that to increase efficiency and performance considerate is possible to simply give the nanopillars supra-wavelength dimensions to mimic freeform metalens design, however, this approach lowers the density of effective material on a given metasurface. However, the combination of the nanopillars and nanograting produced by merging the nanopillars as part of the optimization advantageously balances the focal efficiency of supra-wavelength structures with a density of sub-wavelength structures.

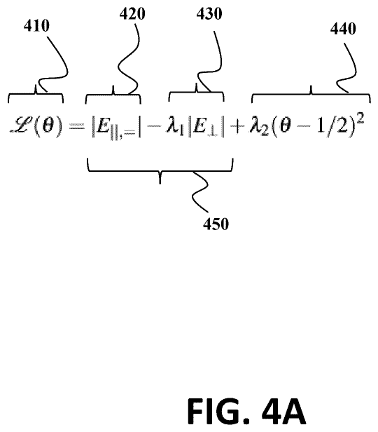

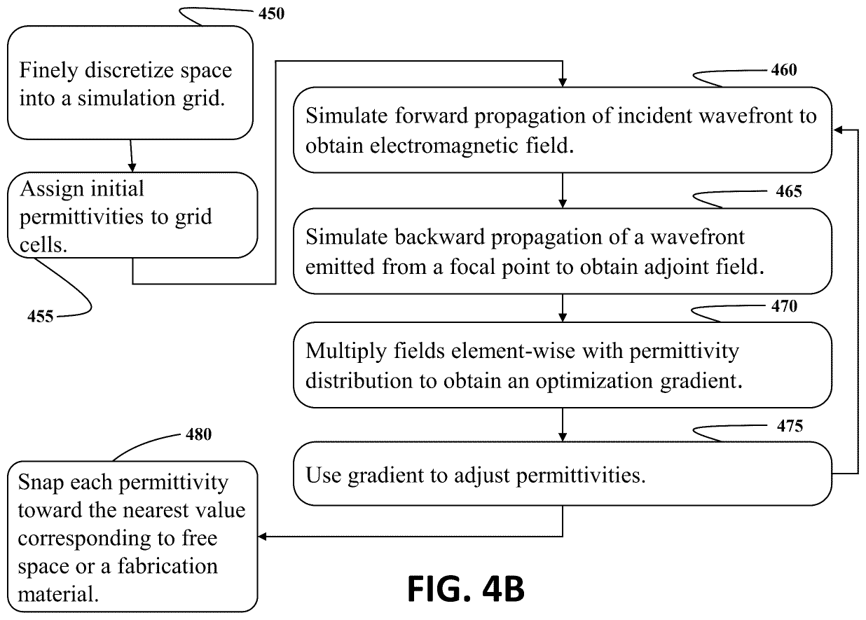

FIG. 4A shows a schematic of an optimization problem solved by some embodiments to improve the focal efficiency of the metalens with hybrid topology. In this embodiment, the cost function 410 is probabilistic such that the optimization of this cost function provides a field θ of probabilities where θ_{xy}=1 if the matter is to be deposited on the substrate at (x,y) and θ_{xy}=0 if not. An occupancy map allows to design hybrid topology of various complexities to achieve the desired focal efficiency, while the probabilistic estimation of the occupancy map allows to consider variations of the topologies achieving similar objectives. Furthermore, the occupancy map contains parameters regarding position and orientation of the metalens topology as well as details of optimization.

To that end, the cost function includes energy term 450 designed to increase the focal efficiency and reduce the energy spill, and optional binarization term 440 which encourages occupancy values near 0 and 1. In some implementations, the energy term 450 includes a focal efficiency term 420 representing the total energy correctly delivered to the vertically polarized focal point when the metalens is illuminated with a plane wave and a spill term 430 representing the total energy of vertically polarized light incorrectly delivered to the horizontally polarized imaging area (and vice versa).

Although maximizing the focal efficiency term 420 implies minimizing the spill term 430, it does not necessarily play out that way in optimization. 100% efficiency is unattainable for physical reasons, so the term 420 may plateau before all spill is resolved. The second term 430 serves to “push” away the light that is incorrectly scattered to the wrong target zone on the sensor. Much of this incorrectly scattered light is moved to the correct target zone, where the first term then nudges it to the appropriate focal point. Some of the incorrectly scattered light is pushed off the sensor entirely and lost, but in doing so the noise in the polarization sorting is reduced, which is advantageous for the subsequent comparison of sensor values for scene reconstruction.

FIG. 4B shows principal steps involved in optimizing freeform design. The space is discretized 450 into a fine 3D grid, typically 5 nanometer resolution, and each grid element is assigned a permittivity 455, usually corresponding to the distribution of free space and solid material in the initial nanopillar design. The adjoint method is used to calculate the gradient of the performance objective with regard to the permittivities, as follows: The electromagnetic field induced by forward propagation of the incident wavefront through the device is obtained by solving Maxwell's equations 460. The electric field at a desired focal point is extracted from this solution, and the electromagnetic field induced by propagating that field backward from the focal point is obtained by solving Maxwell's equations 465. These forward field, permittivity field, and adroit field are multiplied 470 element-wise to obtain the gradient of the focal term 410 in the objective. The gradients of the spill terms 420 are calculated the same way, but for other focal points. The gradients of the binarization 430 and ease-of-fabrication 440 terms are calculated algebraically from the permittivity distribution. Finally, all gradients are added and the result is used to adjust the permittivities 475. This repeats until the value of the objective reaches a satisfactory threshold or it ceases to improve. Then each permittivity value is snapped 480 to the nearest value of a fabrication material or free space.

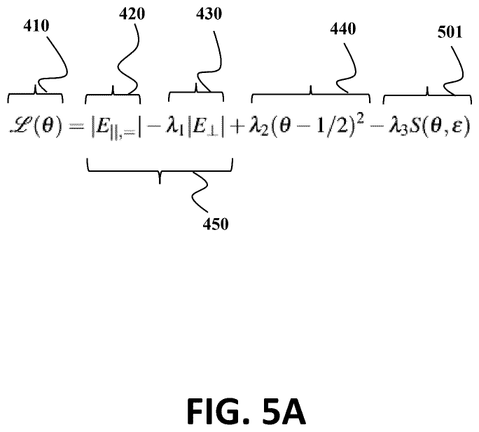

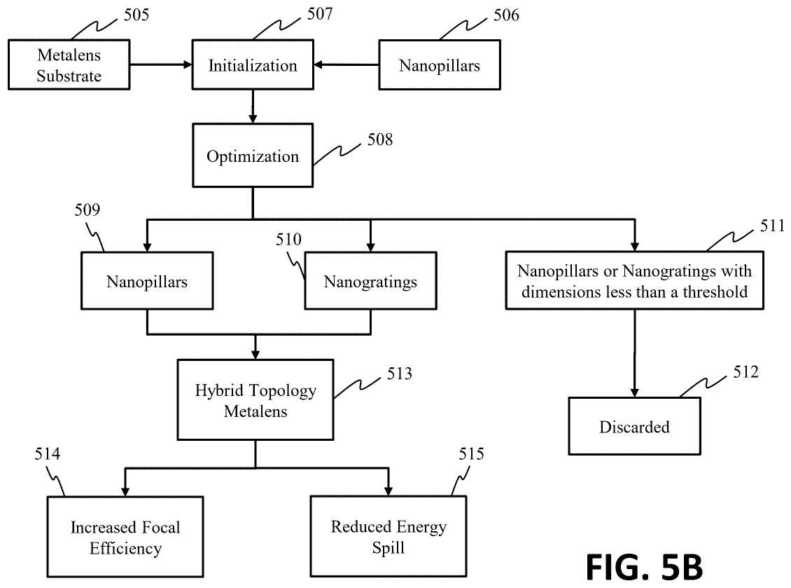

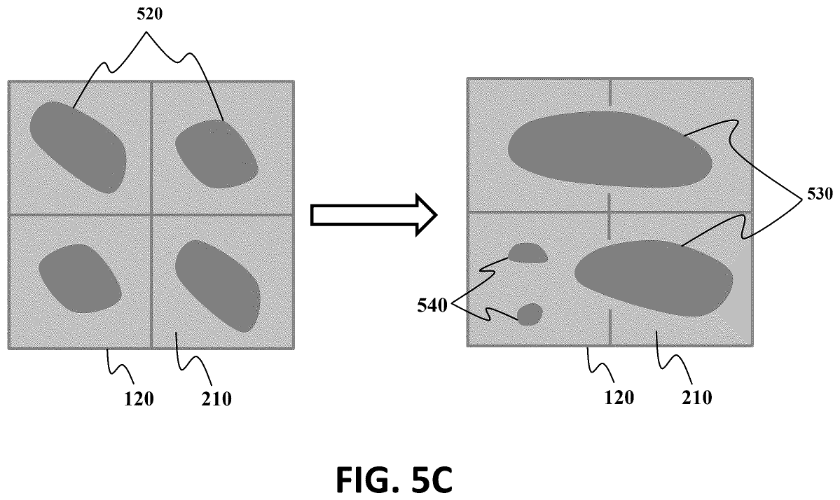

FIG. 5A shows a schematic of an optimization problem solved by some embodiments to improve the focal efficiency of a hybrid topology metalens. In this embodiment, optimization of cost function 410 is achieved by incorporating the morphology term 501. Morphology term 501 is a penalty assessed to structural features (islands, holes, bridges, ravines) that are too small to be made with current fabrication technology.

The morphology term 501 is computed by convolving the occupancy field θ with a center-surround kernel (e.g., Laplacian-of-Gaussian or Ricker wavelet) that is tuned to highlight gaps and blobs that are too small to fabricate (e.g., less than 40 nm in at least one direction). Minimizing the squared difference between the filter response and the occupancy values tends to erode blobs and fill gaps that are smaller than the target size, while the structure boundaries are still being tuned by the focal efficiency terms.

In some embodiments the morphology term 501 is kept inactive (λ₃=0) until optimization of the first two terms, focal efficiency 420 and spill 430, plateaus. Ultimately, the morphology term 501 is activated with a rising λ₃>0 and the optimization proceeds a few more iterations to clean up non-fabricable features.

FIG. 5B shows a flowchart for achieving a hybrid topology metalens 513 according to some embodiments. A nanopillar topology metalens is obtained through initialization 507 of a metalens substrate 505 with nanopillars 506. Initialization 507 occurs by populating metalens substrate 505 with nanopillars 506, the configuration of which can be pre-selected from a library and adjusted for the design task at hand. Optimization 508 of the initialized metalens populated with nanopillars 506 produces nanopillars 509 and nanogratings 510. The resulting nanopillars 509 and nanogratings 510 vary and can be analyzed by their orientation, size, sub-wavelength, and supra-wavelength dimensions with respect to the incoming electromagnetic light. Optimization 508 may produce nanopillars or nanogratings that contain dimensions less than a desired threshold 511. The threshold can be determined beforehand according to the design task.

For example, some embodiments can require that any given nanostructure contains no dimensions less than 40 nm in at least one direction. The morphology term 501 of the optimization suggests removing such nanostructures from the topology, which may be discarded 512. Discarding such nanostructures, creates space on the metalens surface for other nanostructures and/or brings the metalens closer to the design objective. The removal of nanostructures, which may take the form of nanopillars or nanogratings, less than a threshold 511 is not always a necessity and/or can be addressed by morphology term 501 based on the design task at hand.

Ultimately, the nanopillars 509 and nanogratings 510 produced by optimization 508 form a hybrid metalens topology 513. The resulting hybrid metalens topology 513 exhibits increased focal efficiency 514 and reduced energy spill 515.

FIG. 5C shows a patch of metalens 120, before and after optimization according to an embodiment of the present disclosure. The initial patch of metalens 120 contains irregularly shaped nanopillars 520 arranged throughout square grid cells 210. In some embodiments, the irregularly shaped nanopillars 520 can have convex properties. In this embodiment of the present invention, optimization generates nanogratings 530 and shapes 540, both having convex properties. The dimensions of shapes 540 are less than a threshold and thus are too small to fabricate. The morphology term 501 of the optimization function suggests eroding shapes 540 in foresight of manufacturing. In this instance, nanogratings 530 have dimensions greater than a threshold and are kept intact for fabrication.

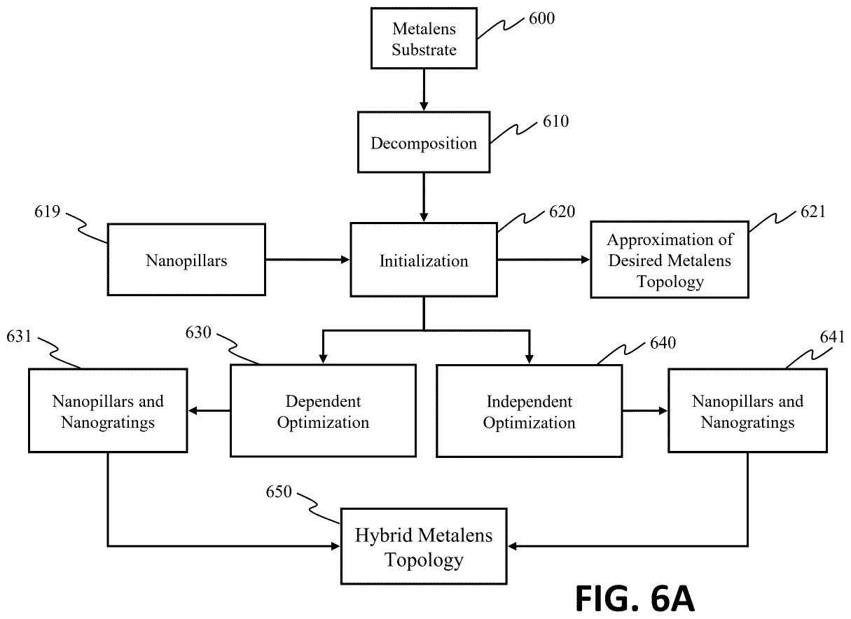

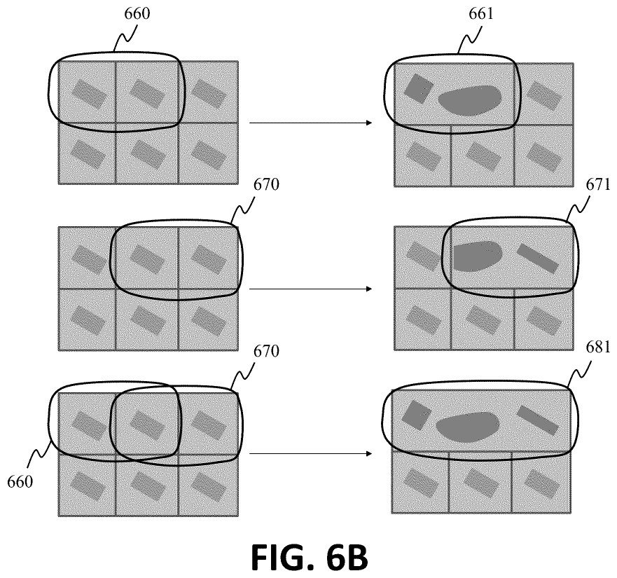

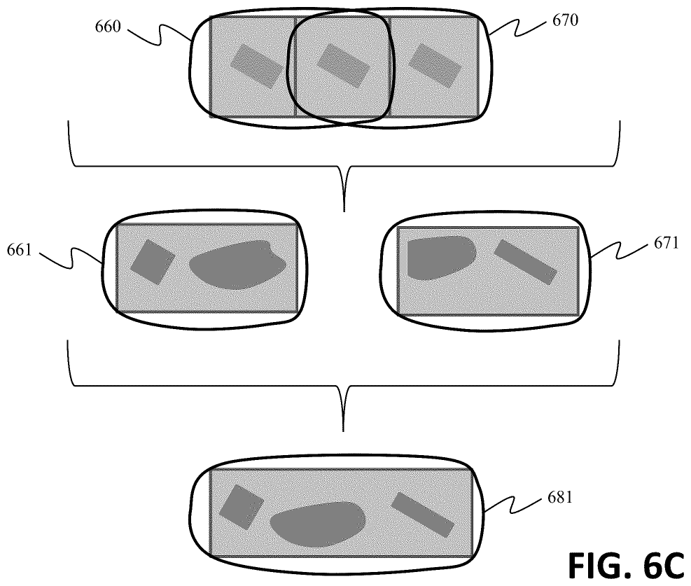

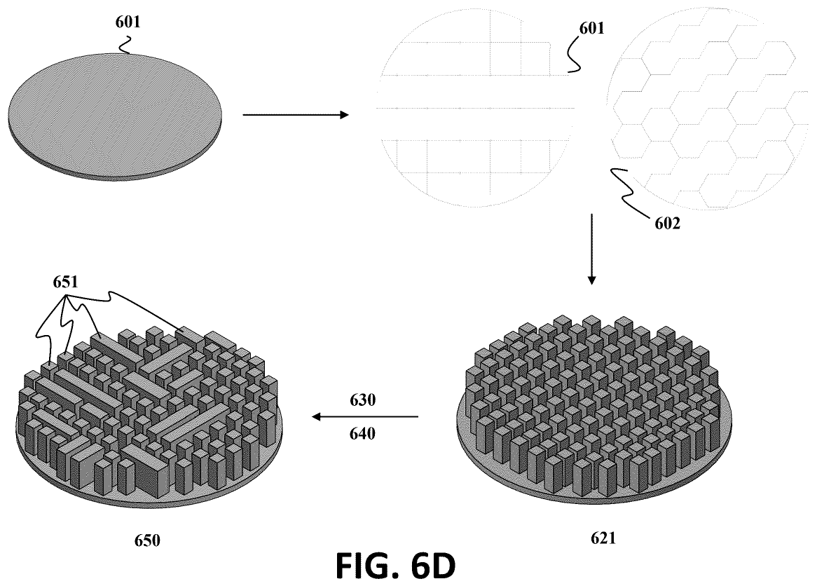

FIG. 6A shows a flowchart for achieving a hybrid metalens topology by either dependent optimization 630 or independent optimization 640 according to some embodiments. Metalens substrate 600 undergoes decomposition 610 and initialization 620, in which the metalens substrate 600 is populated with nanopillars 619 in sub-wavelength scale tiles to produce a nanopillar topology. The configuration of nanopillars 619 on metalens substrate 600 can be pre-selected from a library and adjusted for the design task at hand, providing an approximation of the desired metalens topology 621. After initialization, either dependent optimization 630 of the entire metalens or independent optimization 640 can result in a hybrid metalens topology 650.

First, the metalens substrate 600 undergoes decomposition 610, which decomposes a metasurface into a grid of subwavelength-sized atoms or cells, each of which can be chosen independently from its neighbors to provide a local phase delay in the near field. Each unit cell contains a nanopillar which provides different phase delays to different polarizations of incident light. Phase delay of silicon nitride nanopillars depends on the polarization direction of the incident wavefront, thus it is possible to make a table of the phase delays to provided horizontally and vertically polarized light by different pillar geometries. Two design motifs are 1) metalenses that produce 4 complete focused images with 0°, 45°, 90°, 135°polarization and 2) metalenses that produce many small, focused images of varied polarization, which are later combined and upscaled via super-resolution methods. The motivation for the latter is there is a there is a trade-off between polarization-sorting efficiency and achieving steep refractive angles, which necessitates longer focal lengths in the former design. In addition, both strategies suffer from spill due to unmodelled effects of decomposition, and this makes subsequent comparison of differently polarized images a very noisy process.

3D scene geometry can be inferred directly from as little as two differently polarized images via regularized optimization, giving way to a metalens that provides those images in a single exposure. This improves over 4-polarization system in that more pixels can be inferred with the same aperture, but it also exhibits slightly more sensitivity to spill. Some embodiments call for a completely freeform design, optimized via the adjoint method and validated in Rigorous Coupled Wave Analysis (RCWA). Full-metalens freeform topology optimization is considered prohibitively expensive from a computational point of view. Thus, some embodiments require identifying conditions, a figure of merit, and an optimization strategy that yields a highly efficient metalens in a practical amount of time.

After initialization 620, dependent optimization 630 of the nanopillar metalens topology yields nanopillars and nanostructures 631. In some instances, dependent optimization 630 of the metalens surface topology occurs over the entire grid, instead of partitioning the metalens into sections and optimizing sequentially. Rather, dependent optimization 630 of the entire metalens is a recursive process on which the shape of each sub- or- supra-wavelength structure is optimized jointly in dependence on each other as part of one optimization routine. Hence, such an optimization is referred to herein as “dependent optimization.” Ultimately, dependent optimization 630 of a fully assembled metalens is computationally expensive that yields relatively small gains relative to independent optimization 640 but can still provide a hybrid metalens topology suitable for the design task at hand.

Alternatively, some embodiments call for independent optimization 640, which partitions the existing cellular arrangement (square hexagonal, bipolar, or a hybrid of any of the two listed arrangements) into domains or tiles. The domains or tiles created from partitioning the metalens grid can overlap at their edges. Furthermore, each domain is independently optimized with negligible inconsistency at the edges, hence the name independent optimization 640. The results of the optimization in the overlapping cells are converging or at least not diverging. Alternatively, independent optimization can be referred to as the overlap method or sliding window method. In some embodiments independent optimization 640 elongates and merges nanopillars 619 to form supra-wavelength-scale bars and crosses that are oriented with the controlled polarization directions, leading to structures that locally resemble superimposed blazed gratings also referred to as nanogratings.

Optimizing tiles independently and then stitching them together yields a hybrid metalens topology 650 made up of nanopillars and nanogratings 641, providing improved focal efficiency and reduced energy spill.

FIG. 6B shows an instance of independent optimization, according to an embodiment. Initialized design of the metalens formed by the collection of nanopillars arranged within the corresponding cells is partitioned into tiles, each tile includes multiple pillars. In this example, the tile 660 contains two nanopillars, each situated on a substrate in a planar grid cell, located on a metalens. Tile 661 features a nanopillar, a nanograting, and is the result of the optimization of tile 660.

Tile 670 similarly contains two nanopillars, each situated on a substrate in a planar grid cell, located on a metalens. Optimized tile 671 also features a nanopillar, a nanograting, and is the result of the optimization of tile 670. Stitching together optimized tiles 661 and 671 results in tile 681, containing nanopillars and nanogratings. Although there may be minor differences in the overlap of optimized tiles 661 and 671, the resulting tile 681 is converging or at least not diverging. So, in one embodiment the shapes belonging to the overlapping portions of the tiles are just averaged to produce the merged tiles 681.

FIG. 6C shows an alternate representation of independent optimization, according to an embodiment of the current invention. The optimization of tiles 660 and 670 yields tiles 661 and 671, respectively. Stitching together optimized tiles 661 and 671 results in tile 681, which contains a collection of nanopillars and nanogratings. The results of the optimization in the overlapping cells are converging as shown in tile 681 or at least not diverging.

FIG. 6D shows a schematic of a method for metalens topology optimization according to an embodiment of the current invention. The initial substrate 600 of the metalens is discretized into a real-valued array. Subsequently, the real-valued array is formed into a cellular arrangement 601 and/or 602, which according to the present embodiment in FIG. 6D is shown to be either grid-like 601 or hexagonal 602, respectively. The planar grid cells are populated with nanopillars, which have been pre-optimized for a design task such as far-field focal efficiency, resulting in an approximation of the desired metalens topology 621. Hybrid surface topology metalens 650 is achievable by dependent optimization 630 or independent optimization 640 of the approximation of the desired metalens topology 621.

Although dependent optimization 630 of the entire metalens is computationally more expensive than the independent optimization 640, both dependent optimization 630 and independent optimization 640 yield a hybrid surface topology metalens 650. The resulting hybrid topology metalens 650, which features a collection of nanopillars and nanogratings 651, is capable of increased focal efficiency and reduced energy spill.

### Exemplar Design Embodiment: Designing a Metalens for Far-Field Polarization

This exemplar embodiment is provided for illustrational purposes without intending to limit the scope of various embodiments of the present disclosure.

In this exemplar embodiment, the design is optimized by discretizing the metalens surface into a real-valued occupancy array θᵢⱼ∈[0,1] at 5 nm pitch, and computing the gradients of the figure of merit with respect to array θ via the adjoint method. This requires two full simulations of wave propagation through the device. At present, whole-device gradients are impractical because one iteration takes two days on our computer cluster. Given suitably structured initial conditions, some embodiments allow the problem to be partitioned into 4λ×4λ-domains that overlap by λ/2 at their edges, such that each domain can be independently optimized with negligible inconsistency at the edges. A trial introduction of an edge-consistency term into the figure of merit did not alter the course of the optimization nor its final result.

In some embodiments open-source simulator MEEP can obtain near-field information from Rigorous Coupled-Wave Analysis (RCWA), a Raleigh propagator can obtain far-field intensities, the adjoint method computes gradients with respect to a figure of merit, and the Method of Moving Asymptotes (MMA) optimizes. MMA constructs a convex separable proxy function from recent gradient samples; this function is easy to optimize and, under modest regularity conditions, can be considered a lower bound on the figure of merit.

The discovery of the following interventions improve both optimization speed and results: The initial field is “softened” to non-binary values via Gaussian convolution to prevent lock-in. Every 5 iterations the field is averaged with its own binarization, which accelerates the solidification of the interiors of structures. The morphology term is kept inactive (λ₃=0) until optimization of the first two terms plateaus. It is then activated with a rising λ₃>0 and the optimization proceeds a few more iterations to clean up non-fabricable features.

### Exemplar Embodiment: Initial Conditions

In some embodiments, initialization begins with a 40 μm×20 μm surface and an aim to focus a 532 nm plane wave two images to two points 20 μm apart at a distance of 33 μm. The single layer freeform metalens is voxelated at 10 nm pitch yielding an optimization problem with 8×106 binary variables, which is relaxed to continuous variables in [0,1].

Since gradient ascent in the figure of merit can only guarantee convergence to a local optimum, a favorable initialization plays a large role in the quality of the final result. Initialization 620 allows starting design with a high-efficiency nanopillar design in which the planar dimensions of rectangular nanopillars have been pre-optimized for far-field focal efficiency. Then the substrate may be partitioned into cellular arrangements: a square grid; a hexagonal grid; or a bipolar grid where nano-pillars are arranged on iso-phase delay contours of the two (horizontal and vertical) focal points. In simulation, the bipolar arrangement provided the highest focal efficiency, but only in zones on the metasurface where the pillar density is ≈0.4λ. The square and hexagonal arrangements provided nearly equal efficiency.

Typically, hexagonal arrangements are more efficient, but in our setting the hexagonal arrangement was more prone to unwanted cross-polarization spill. Some embodiments call for hybrid cellular arrangements, one of which being a bipolar grid in zones where it is dense with a square grid elsewhere.

The method of independent optimization tended to elongate and merge pillars to form supra-wavelength-scale bars and crosses that are oriented with the controlled polarization directions, leading to structures that locally resemble superimposed blazed gratings, alternatively referred to as nanogratings.

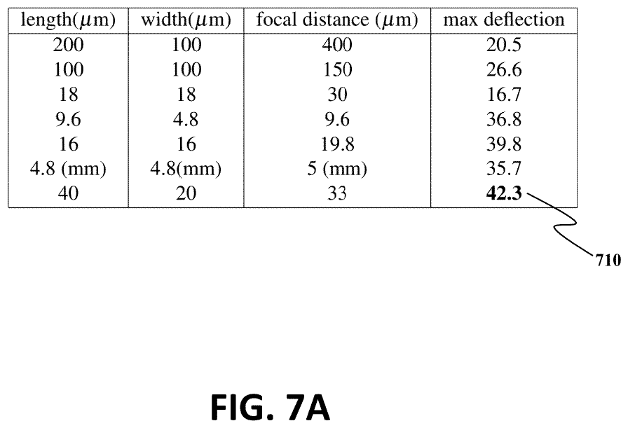

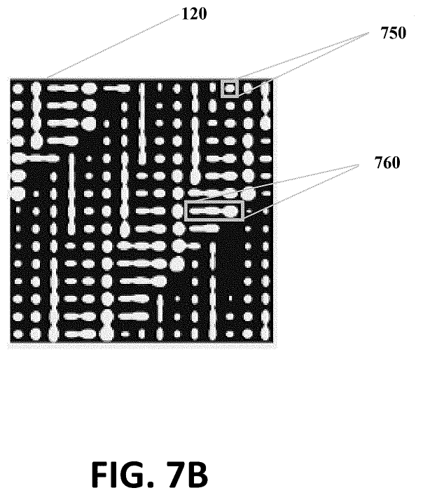

In some embodiments, a square grid proved to be most favorable to this process, leading to highest focal efficiency and lowest cross-polarization spill. Furthermore, optimizing all patches independently and stitching together the results yielded a metalens with 42% higher focal efficiency than leading nanopillar metalenses. The proposed method of independent optimization also yielded the highest deflection angle yet reported for a bifocal lens of 42.3 ° as shown by 710 in FIG. 7A. Alternatively, dependent optimization of the fully assembled metalens—a computationally costly affair—yielded only small gains, bringing the total improvement up to 43%.

FIG. 7A shows a table illustrating the maximum deflection angle of a hybrid topology metalens. The exemplar embodiment shows how to achieve a maximum angle of 42.3°, referred to as 710 in FIG. 7A.

FIG. 7B shows a top view patch of a metalens 120, according to the exemplar embodiment described in 7A. The hybrid topology metalens patch 120 contains an arrangement of nanopillars 750 and nanogratings 760, resulting from independent optimization.

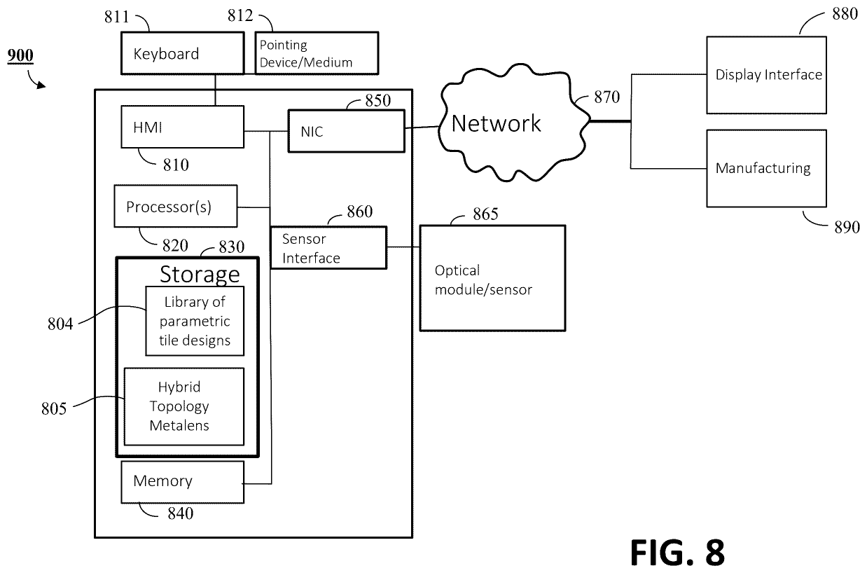

FIG. 8 shows an example configuration of a computing module 800 according to embodiments of the present disclosure. The computing module 800 may include a human machine interface (HMI) 810 connectable with a keyboard 811 and a pointing device/medium 812, one or more processors 820, a storage device 830, a memory 840, a network interface controller 850 (NIC) connectable with a network 870 including local area networks, wireless networks and internet network, a sensor interface 860 connected to an optical module/sensor 865.

The memory 840 may be one or more memory units, operating with the storage 830 that stores computer executable programs (algorithm codes) for selecting a nanopillar topology from the library of parametric tile designs 804 in connection with the processor 820. The NIC 850 includes a receiver and transmitter to connect to the network 870 via wired-networks and via wireless-networks (not shown). After the computing module 800 executes optimization the resulting hybrid topology metalens 805 is kept in storage 830 by use of the processor 820 and memory 840. Storage 830 may include a library of parametric designs 804 and/or hybrid metalens topologies 805 obtained after optimization. The memory 840 and the storage device 830 may be referred to as a memory for convenience. Upon completion of optimization, any hybrid topology metalens 805 contained in storage 830 may be uploaded through NIC 850 to a given network 870, which may feature wired or wireless communication links. The hybrid topology metalens may then be projected on a display interface 880 or transferred for manufacturing 890.

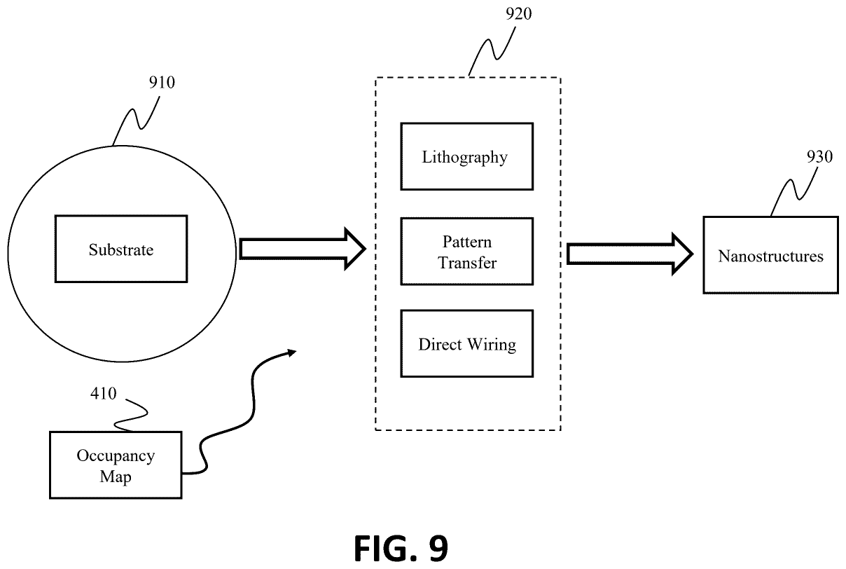

FIG. 9 shows a diagram illustrating an overview of the manufacturing process relative to a hybrid topology metalens design as an occupancy map 410, which guides methods of metalens fabrication 920 according to some embodiments. The process begins by choosing an appropriate substrate 910 material for the design task at hand. Substrates 910 used in metasurface fabrication can vary based on the method and application. Common materials include silicon, glass, and flexible polymers like PDMS (polydimethylsiloxane). Substrate 910 and occupancy map 410 further allow for manufacturing to continue to fabrication.

Some exemplar methods of metalens fabrication 920 are lithography, pattern transfer, and direct wiring. Electron-Beam Lithography (EBL) uses a focused beam of electrons to write custom patterns on a resist-covered substrate with high precision. EBL is a slow process but is suitable for research and small-scale production due to its high resolution. Photolithography on the other hand is suitable for mass production because of its lower resolution and is achieved by using light to transfer a geometric pattern from a photomask to a light-sensitive chemical photoresist on the substrate.

Nano-Imprint Lithography (NIL) is a pattern transfer method that involves pressing a mold with nanoscale features into a polymer layer on a substrate. The process is followed by curing and mold removal, transferring the pattern. This method is cost-effective and suitable for high-throughput manufacturing, but it's limited by lower aspect ratios and potential defects.

Two-Photon Polymerization (TPP) is a direct wiring method that utilizes a femtosecond laser to induce polymerization in a photosensitive material, enabling the creation of complex 3D structures at the nanoscale. TPP offers high resolution and flexibility in design but is slower and more suitable for prototyping and low-volume production.

All three of the described metalens fabrication processes 920 can manufacture nanostructures 930. The optimization process that produces a hybrid topology metalens can be integrated with any of the fabrication methods 920, providing incentive to deliver a higher efficiency system capable of procuring further innovation.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium.

The above-described embodiments of the present disclosure can be implemented in any of numerous ways. For example, the embodiments may be implemented using hardware, software or a combination thereof. Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

1. A metalens with a hybrid surface topology including a collection of nanopillars and a collection of nanogratings.

2. The metalens of claim 1 configured to manipulate an incoming field of electromagnetic light, wherein each of the nanopillars has sub-wavelength dimensions with respect to the wavelength of the electromagnetic light, wherein each of the nanogratings has at least one supra-wavelength dimension with respect to the wavelength of the electromagnetic light.

3. The metalens of claim 1, wherein the nanopillars are arranged on a grid of cells having sub-wavelength dimensions, and wherein a nanograting is formed by merging shapes of at least two nanopillars in neighboring cells.

4. The metalens of claim 1, wherein the nanopillars and the nanogratings have irregular shapes.

5. The metalens of claim 4, wherein each irregular shape is formed by a combination of shapes with dimensions greater than a threshold.

6. The metalens of claim 1, wherein the hybrid surface topology is formed by optimizing a nanopillar topology with an objective of focal efficiency and minimum energy spill of the metalens with the hybrid surface topology.

7. The metalens of claim 1, wherein the hybrid surface topology is optimized over a collection of overlapping tiles, each tile including multiple unit cells containing nanopillars.

8. A method for designing the hybrid surface topology of claim 1, wherein the method uses a processor coupled with stored instructions implementing the method, wherein the instructions, when executed by the processor carry out at least some steps of the method, comprising:
determining a nanopillar topology of the metalens to perform a desired task; and
solving an optimization problem optimizing a topology of the metalens initialized with the nanopillar topology to improve one or a combination of a focal efficiency and energy spill of the optimized topology to produce the hybrid surface topology.

9. The method of claim 8, wherein the optimization problem defines an occupancy map of the optimized topology as a cost function of a focal efficiency term representing total energy delivered by illuminating the metalens and a spill term representing a spill of the total energy produced by the illuminated metalens.

10. The method of claim 9, wherein the focal efficiency term represents the total energy correctly delivered to a vertically polarized focal point of the illuminated metalens, and wherein the spill term represents the total energy of vertically polarized light incorrectly delivered to a horizontally polarized imaging area of the illuminated metalens.

11. The method of claim 9, wherein the occupancy map includes binary occupancy values, and wherein the cost function is probabilistic and includes a binarization term that encourages occupancy values near 0 and 1.

12. The method of claim 9, wherein the cost function includes a morphology term as a penalty on outliers in structural features of the optimized topology.

13. The method of claim 8, further comprising:
solving the optimization problem iteratively and jointly until a termination condition is met to produce elements of the hybrid topology in dependence on each other upon meeting the termination condition.

14. The method of claim 8, further comprising:
partitioning the nanopillar topology into a collection of overlapping tiles, each tile includes multiple unit cells containing nanopillars;
solving the optimization problem for each tile independently from solutions of the optimization problem for other tiles; and
combining solutions of the optimization problem for different tiles to form the hybrid surface topology.

15. The method of claim 8, wherein for determining the nanopillar topology, the method further comprising:
collecting the desired task from a library of tasks; and
retrieving the nanopillar topology, over wired or wireless communication link, from a library of nanopillar topologies indexed on tasks in the library of tasks.

16. The method of claim 8, further comprising:
determining the nanopillar topology using forward or inverse design employing decomposition of the substrate surface of the metalens.

17. A method of metalens topology optimization, wherein the method uses a processor coupled with stored instructions implementing the method, wherein the instructions, when executed by the processor carry out at least some steps of the method, comprising:
initializing a topology of a metalens using a collection of nanopillars arranged on a substrate; and
optimizing the collection of the nanopillars to produce a hybrid topology for nanostructures of the metalens including nanopillars and nanogratings.

18. The method of claim 17, wherein the nanostructures of optimization have dimensions greater than a threshold.

19. The method of claim 17, wherein the nanostructures of optimization have irregular shapes.

20. A method for manufacturing a metalens, comprising:
collecting a hybrid surface topology of a metalens including a collection of nanopillars and a collection of nanogratings; and
manufacturing the metalens having the hybrid surface topology.
